(19) United States
(12) Patent Application Publication
(10) Pub. No.: US 2014/0008149 A1
(43) Pub. Date: Jan. 9, 2014

(54) TREE STAND

(71) Applicant: Edward Z. Fogel, Alma, AR (US)

(72) Inventor: Edward Z. Fogel, Alma, AR (US)

(21) Appl. No.: 13/542,306

(22) Filed: Jul. 5, 2012

(51) Int. Cl. A01M 31/02

(52) U.S. Cl. 182/129; 182/223

(57) ABSTRACT

A tree stand for use in such sports as hunting deer. The tree stand comprises a platform; a seat; first and second vertical frame members, each defining an upper end and a lower end; and a cross-member located between the upper ends of the first and second vertical frame members. The seat is pivotally connected to the upper ends of the first and second vertical frame members. The platform is pivotally connected to the lower ends of the first and second vertical frame members. The platform is made up of a middle section, and first and second outer sections. The first and second outer sections pivot between an open coplanar support condition and a folded transport condition.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

This invention relates to tree stands.

### BACKGROUND OF THE INVENTION

Portable tree stands allow a hunter to gain a vantage point for the purposes of better viewing his surroundings by perching atop the stand which is removably secured to a tree trunk. A review of the prior art follows.

U.S. Pat. No. 5,186,276 describes a portable hunting tree stand adapted to be removably connected to a tree trunk comprising a platform, a seat, at least one frame member connected between the seat and platform, and arm means connected to the frame member for hanging a hunting bow thereon so that a hunter's hands may remain free and unencumbered while the hunter is seated atop the seat and while the bow is not in use, and wherein the bow is easily reached by the hunter when the hunter desires to use the bow. The arm means is an arm pivotally connected to a frame member, and includes a U-shaped bracket connected thereto wherein a bow may be removably placed therein. In another embodiment, the tree stand comprises a platform, a seat, at least a first frame member connected between the seat and the platform, at least a second tubular frame member connected to the first frame member, and arm means connected to the tubular member by inserting one end into the tubular member. In another embodiment, the tree stand comprises a platform, a seat, at least one frame member connected between the seat and platform, at least one cable connected between the frame member and the platform, and arm means connected to the cable.

Typically, a portable tree stand comprises a platform, a seat, and one or more frame members which connect the seat to the platform. Ordinarily these frame members are collapsible to allow the platform and seat to be folded into a compact configuration for transportation.

A brief review of the prior art follows.

U.S. Pat. No. 4,458,782 describes a seat assembly particularly adapted for support upon the inclined side frame members of the Baker tree stand (U.S. Pat. No. 3,460,649). The seat assembly includes an elongated seat member transversely spanning the side frame members and being provided with depending legs resting upon the side frame members, and a pair of hanger straps affixed to the opposite ends of the seat member and projecting upward and rearward, and pin members selectively and detachably connecting the upper ends of the hangers members, behind the seat member, to a set of longitudinally spaced bolt holes in the side frame members.

U.S. Pat. No. 4,474,265 describes a collapsible chair for use by a hunter at an elevational disposition in a tree has a substantially U-shaped frame, a length of padding secured at one end to the cross member and adjustable securing ties and belting to attach the frame and free end of the padding to the tree. When not in use the padding may be folded or rolled about the cross member and tied thereto and the frame may be readily carried.

U.S. Pat. No. 4,997,063 describes a tree stand having a weight bearing platform and a gripping frame hingedly joined thereto utilizes a pair of variable length suspension braces connecting the outer end of the platform to the gripping frame. By varying the length of the braces the platform is leveled while positioned on the tree. The hinged construction also allows for easy folding of the stand for storage and transportation.

U.S. Pat. No. 5,143,177 describes a tree stand comprising a stand portion adapted for releasable attachment to a loop formed from an elongated flexible member that is placed in circumferential relationship with a tree or post.

U.S. Pat. No. 5,234,077 describes a dual frame hunting tree stand has a tree stand top and a tree stand bottom. Each has a tree engagement member attachable to tree hugging arms extendable pivotally from opposite sides of bottom and top frames. A tree piercing prong is attached rigidly in triangular corner bracing relationship to each side of the inside end of each frame. A desirably sharp distal end of each tree piercing prong is positioned to point towards a center of a tree of average diameter for climbing. Seating, arm rests, level adjusters, feet straps, backpack straps, selective tree grabbing elements, selective floor surfaces for the stands and other features are made possible in more advantageous forms as a result of unique structure of this invention.

U.S. Pat. No. 5,363,941 describes an improvement in hunting tree stands which allows for the adaptation of such devices to trees or other support members which may not be truly vertical, thereby providing a level platform and/or seat arrangement irrespective of the orientation of the tree or support member. Leveling is accomplished by a telescopic arrangement attached to the standing platform thereby eliminating the need for ridged braces.

U.S. Pat. No. 5,842,541 describes a portable collapsible platform having a platform, with a mounting edge, a support frame swingably mounted to the mounting edge of the platform and being swingable between a more or less nested portable position closely adjacent the platform, and an extended more or less vertical position, attachments for attaching the support frame to a structure above the ground, flexible strain elements extending between the support frame and the platform to hold the platform, when it is extended, generally horizontal, and, teeth on the mounting edge of the platform, for engaging the structure.

U.S. Pat. No. 6,988,588 describes a climbing tree stand platform including a platform member, the platform member having an inner end for engaging a tree and an outer end, and two sides opposite one another connecting the inner end and the outer end, the platform member having two pivot arm support members rigidly connected thereto and extending upward therefrom toward the inner end of the platform member, each of the pivot arm support members having a pivot arm pivotally connected thereto for pivoting toward and contacting opposite sides of the tree as a downward force is applied to the platform member, each of the two pivot arms being adapted to receive a flexible connector removably connected to each of the two pivot arm support members for extension around the tree to hold the platform member to the tree.

U.S. Pat. No. 7,370,728 describes a lightweight portable tree stand incorporating a detachable reclining seat which is used in an elevated position removably affixed to a tree's trunk. With the recliner tree stand installed on a tree and the user sitting in a reclined position, and upon seeing the quarry, stands, releases the seat, and then has easy access to the entire platform allowing for enhanced, mobility, safety, and visibility of the area below. In the user releasing the seat the seat swings to the tree's trunk, this along full access to an otherwise limited surface area.

U.S. Design Pat. No. D373427 shows various views of a prior art tree stand.

U.S. Pat. No. 7,377,361 describes a tree stand for use in hunting and observing wildlife that includes a collapsible platform and collapsible seat support assembly. In several constructions, a platform assembly includes several pivot joints that permit multiple platform sections to fold together. The folding sections may also include frame members that fan fold together. An adjoining seat support and/or seat assembly folds with the platform to widths that accommodate transport. In several other platform constructions, the platform assembly includes several pivot joints that permit perimeter, interior and end frame members and/or multi-section stays to fold. Underlying cross supports, end straps, end caps and wires stabilize and maintain the displacement of the platform frame members and stays. Several alternative seat support assemblies, platform and sling seat assemblies, cable and strap supports are also disclosed in various tree stand combinations.

U.S. Pat. No. 5,842,541 discloses a portable collapsible platform having a platform, with a mounting edge, a support frame swingably mounted to the mounting edge of the platform and being swingable between a more or less nested portable position closely adjacent the platform, and an extended more or less vertical position, attachments for attaching the support frame to a structure above the ground, flexible strain elements extending between the support frame and the platform to hold the platform, when it is extended, generally horizontal, and, teeth on the mounting edge of the platform, for engaging the structure.

None of the above inventions and patents, taken either singly or in combination, is seen to describe the instant invention as claimed.

### SUMMARY OF THE INVENTION

A tree stand for use in such sports as hunting deer. The tree stand comprises a platform; a seat; first and second vertical frame members, each defining an upper end and a lower end; and a cross-member located between the upper ends of the first and second vertical frame members. The seat is pivotally connected to the upper ends of the first and second vertical frame members. The platform is pivotally connected to the lower ends of the first and second vertical frame members. The platform is made up of a middle section, and first and second outer sections. The first and second outer sections pivot between an open coplanar support condition and a folded transport condition.

### BRIEF DESCRIPTION OF THE DRAWINGS

FIG. 1 is an environmental perspective view of a tree stand in a deployed condition according to the present invention.

FIG. 2 shows the tree stand of FIG. 1 in a folded configuration.

FIG. 3 is a rear elevated view of the tree stand of FIG. 1.

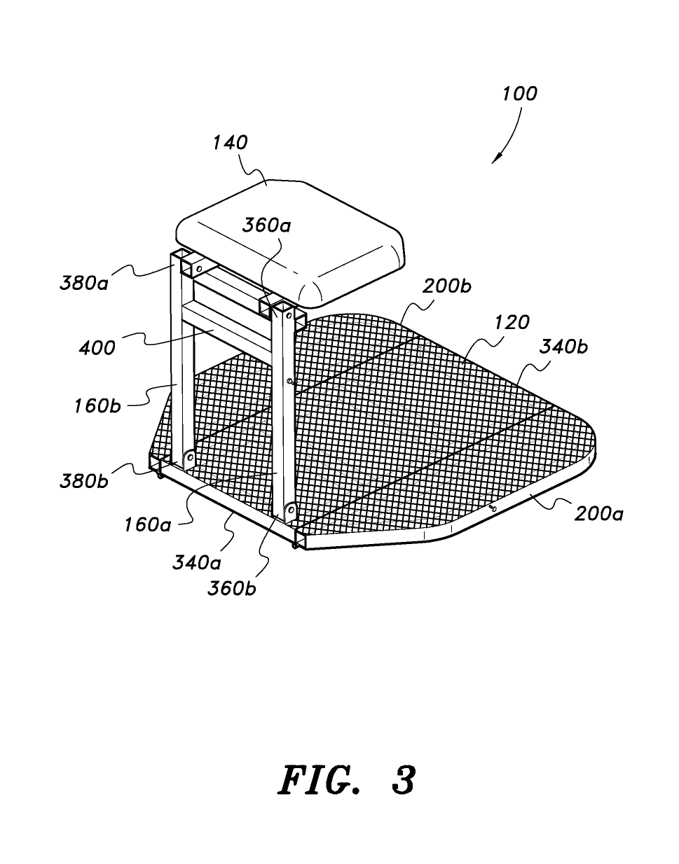

FIG. 4 is an end view of a platform according to the present invention.

FIG. 5 shows an exploded top view of a platform according to the present invention.

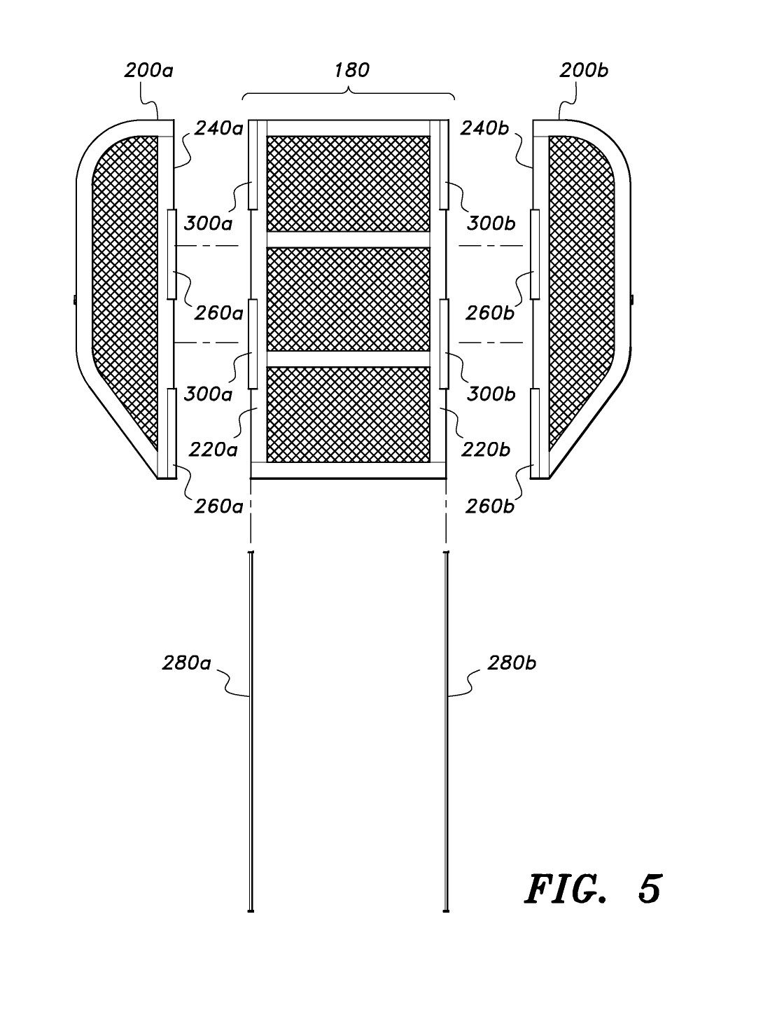

FIG. 6 shows an exploded bottom view of a platform according to the present invention.

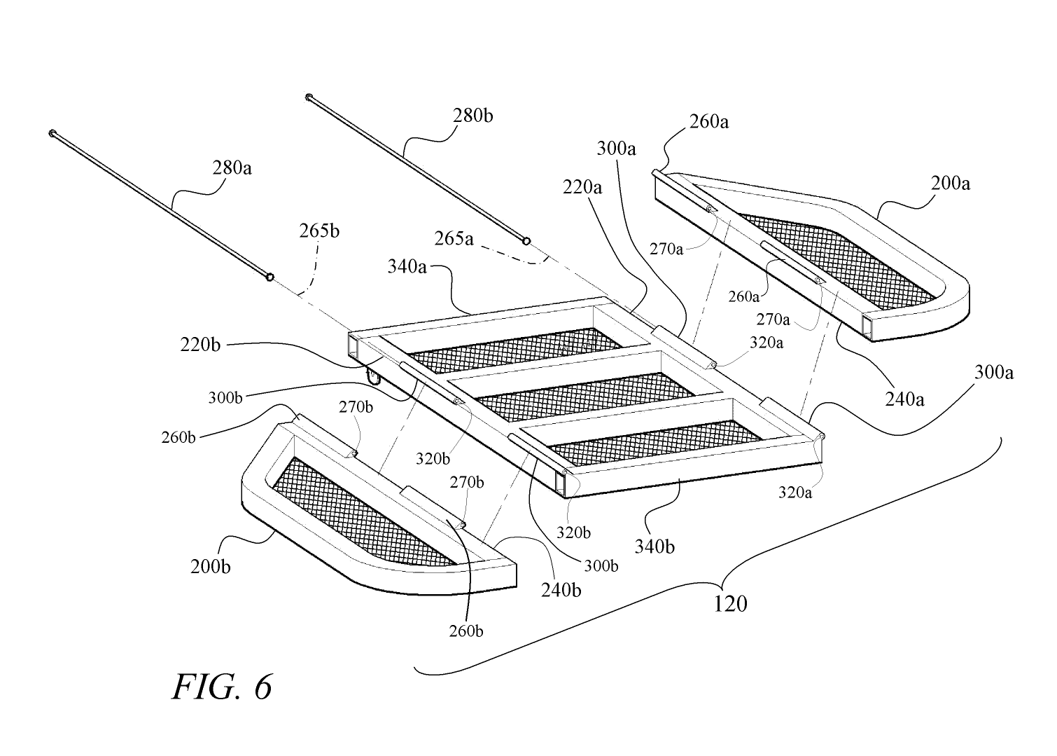

Similar reference characters denote corresponding features consistently throughout the attached drawings.

### DETAILED DESCRIPTION OF THE PREFERRED EMBODIMENTS

This invention relates to tree stands. More specifically, the invention is directed to a man transportable tree stand for securement to a tree. The tree stand of the invention is assigned the numeric label 100; a list of parts is found in Table 1.

Referring to the Figures in general, a tree stand 100 of the invention comprises a platform 120, a seat 140, first and second vertical frame members 160a and 160b connected between the seat 140 and the platform 120. The platform 120 comprises a middle section 180, a first outer section 200a and a second outer section 200b. The middle section 180 further comprises opposite first and second lengthwise sides 220a and 220b, respectively.

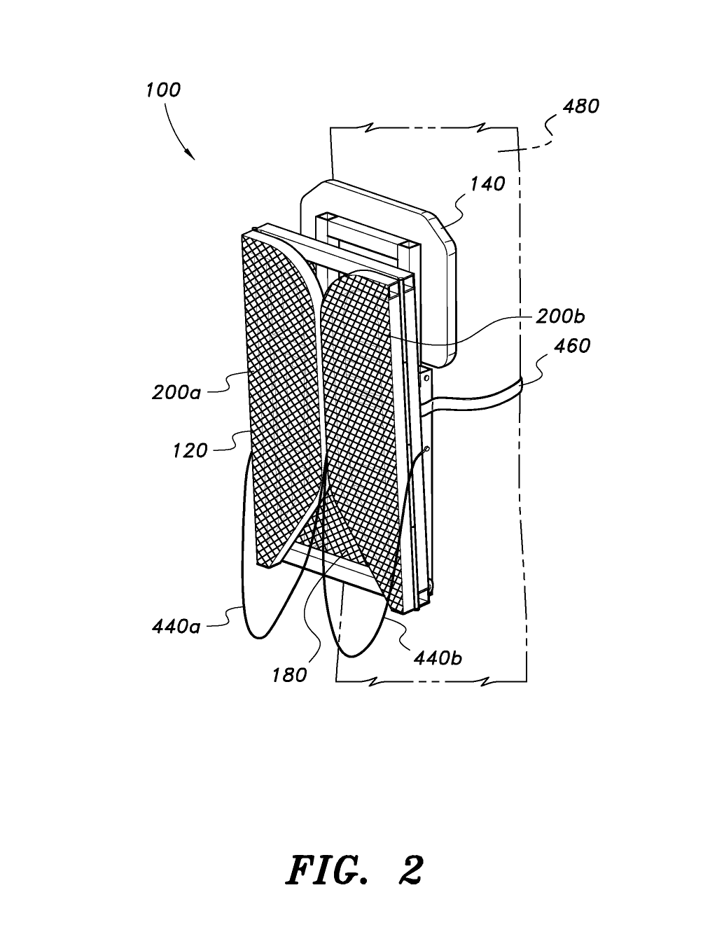

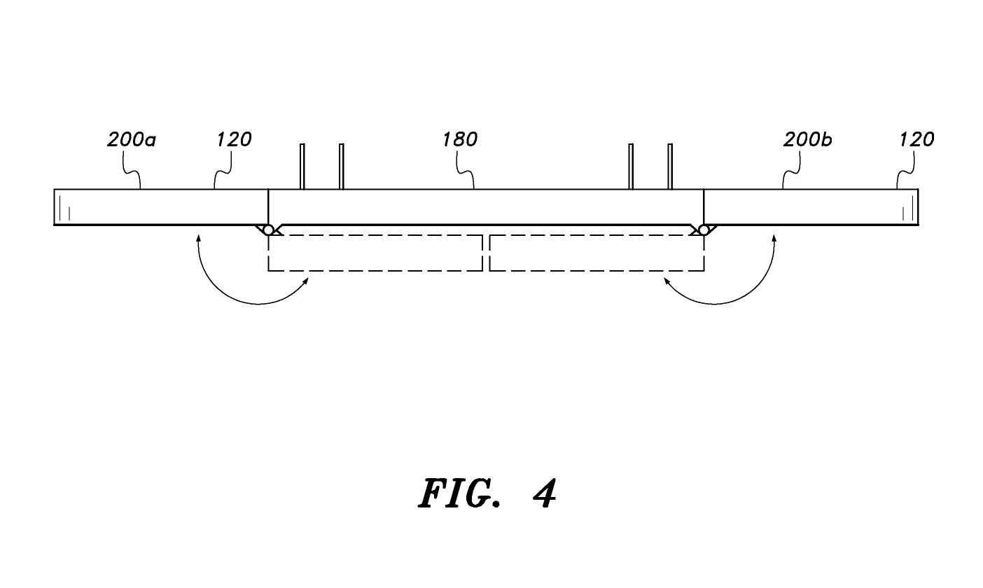

The first and second outer sections 200a and 200b are respectively pivotally coupled to the first and second lengthwise sides 220a and 220b of the middle section 180 such that with respect to the middle section 180 the out sections 200a and 200b pivot between an open coplanar support condition and a folded transport condition as shown in FIGS. 2 and 4.

The first and second outer sections 200a and 200b respectively define first and second inner sides 240a and 240b. The first and second inner sides 240a and 240b respectively define first and second sets of spaced-apart knuckles 260a and 260b each of which define a through-bore represented by numeric labels 270a and 270b, respectively.

The first and second sides 220a and 220b of the middle section 180 respectively define first and second sets of spaced-apart middle section knuckles 300a and 300b each of which define a through-bore represented by numeric labels 320a and 320b, respectively.

The knuckles 260a and 300a align and interlock to form a first common axis of rotation 265a. A first rod 280a is located inside the through-bores 270a of the first outer section 200a and the through-bores 320a of the first side 220a of the middle section 180. The combination of interlocking knuckles 260a and 300a, and rod 280a enables the first outer section 200a to pivot between an open coplanar support condition and a folded transport condition with respect to the middle section 180.

The knuckles 260b and 300b align and interlock to form a second common axis of rotation 265b. A second rod 280b is located inside the through-bores 270b of the second outer section 200b and the through-bores 320b of the second side 220b of the middle section 180. The combination of interlocking knuckles 260b and 300b, and rod 280b enables the second outer section 200b to pivot between an open coplanar support condition and a folded transport condition with respect to the middle section 180.

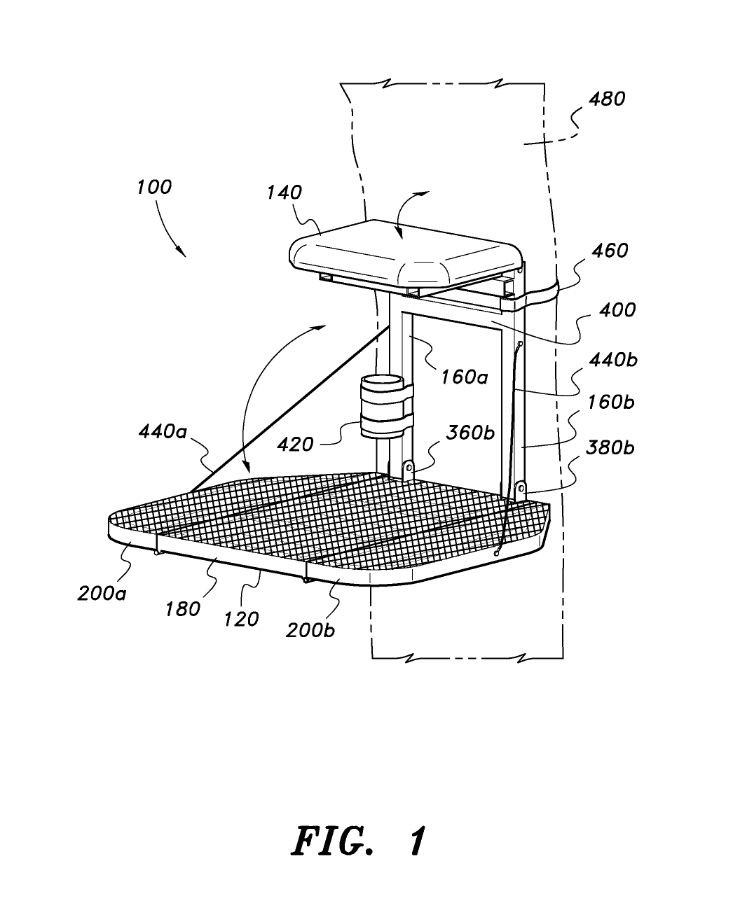

The platform 120 defines front and rear ends 340a and 340b, respectively. First vertical frame member 160a defines upper and lower ends 360a and 360b, respectively. Second vertical frame member 160b defines upper and lower ends 380a and 380b, respectively. The rear end 340a of the platform 120 is pivotally connected to the lower ends 360a and 360b. A cross-member 400 is located between the upper ends 360a and 380a. The seat 140 is pivotally connected to the upper ends 360a and 360b of first and second vertical frame members 160a and 160b such that the seat 140 is moveable between a deployed seating position and a folded transport condition as shown in FIGS. 1 and 2, respectively.

A beverage container 420, such as a flask or thermos bottle, can be affixed to either of the first and second vertical frame members 160a and 160b. First and second cables 440a and 440b are respectively connected between the frame members 160a and 160b and the platform 120. The upper ends 360a and 380a are attached thereto a tree fastening member 460 such as, but not limited to, a cord or chain. During ordinary use of the tree stand 100 the tree fastening member 460 is secured to a tree trunk 480.

TABLE 1

| Part # | |
|---|---|
| 100 | tree stand 100 |
| 120 | platform 120 |
| 140 | seat 140 |
| 160a, 160b | first and second vertical frame members 160a and 160b, |
| | respectively |
| 180 | middle section 180 |
| 200a, 200b | first and second outer sections 200a and 200b, respectively |
| 220a, 220b | first and second lengthwise sides 220a and 220b, respectively |
| 240a, 240b | first and second inner sides 240a and 240b, respectively |
| 260a, 260b | first and second sets of spaced apart knuckles 260a and |
| | 260b, respectively |
| 265a, 265b | first and second 265a and 265b common axes of rotation, |
| | respectively |
| 270a, 270b | through-bores 270a and 270b |
| 280a, 280b | first and second rods 280a and 280b, respectively |
| 300a, 300b | first and second sets of middle section knuckles 300a and |
| | 300b |
| 320a, 320b | through-bores 320a and 320b |
| 340a, 340b | platform front and rear ends 340a and 340b |
| 360a, 360b | first vertical frame member 160a defines upper and lower |
| | ends 360a and 360b |
| 380a, 380b | second vertical frame member 160b defines upper and lower |
| | ends 380a and 380b |
| 400 | cross-member 400 |
| 420 | beverage container 420 |
| 440a, 440b | first and second cables 440a and 440b |
| 460 | tree fastening member 460 |
| 480 | tree trunk 480 |

The invention being thus described, it will be evident that the same may be varies in many ways by a routineer in the applicable arts. Such variations are not to be regarded as a departure from the spirit and scope of the invention.

1-2. (canceled)

3. A tree stand adapted to be removably connected to a tree trunk comprising:
a platform, wherein the platform comprises:
a middle section, the middle section comprising first and second lengthwise sides respectively defining first and second sets of spaced-apart middle section knuckles each of which include a through-bore, wherein the first and second sets of spaced-apart middle section knuckles form an integral part of the first and second lengthwise sides of the middle section;
first and second outer sections, respectively defining first and second inner sides, the first and second inner sides respectively define first and second sets of spaced-apart knuckles each of which include a through-bore,
wherein the first set of spaced-apart knuckles of the middle section and the first inner side of the first outer section align and interlock to form a common axis of rotation,
wherein the second set of spaced-apart knuckles of the middle section and the first inner side of the second outer section align and interlock to form a common axis of rotation; and
a first rod and a second rod, wherein the first rod is located inside the extends through the through-bores of the first outer section and the through-bores of the first side of the middle section, wherein the second rod is located inside the extends through the through-bores of the second outer section and the through-bores of the second side of the middle section, wherein the first and second rods secure the first and second outer sections to the middle section;
a seat;
first and second vertical frame members, each defining an upper end and a lower end; and
a cross-member located between the upper ends of the first and second vertical frame members,
wherein the seat is pivotally connected to the upper ends of the first and second vertical frame members, and
wherein the platform is pivotally connected to the lower end of the first and second vertical frame members such that the platform can be pivotally rotated between a deployed configuration and a folded configuration, and while in the folded configuration the platform is parallel with the first and second vertical frame members while remaining pivotally affixed to the lower end of the first and second vertical frame members.

4. (canceled)

5. The platform according to claim 3 further comprising a beverage container, the beverage container being connected to one of the first and second vertical frame members.

6. The platform according to claim 3 further comprising first and second cables respectively connected between first and second vertical frame members and the platform.
